(19) United States
(12) Patent Application Publication
(10) Pub. No.: US 2008/0231547 A1
(43) Pub. Date: Sep. 25, 2008

(54) Dual image display device

(75) Inventors: Ken Yagiura, Tottori (JP); Atsushi Kanehira, Tottori (JP); Yusuke Okazaki, Tottori (JP); Toru Fukui, Tottori (JP)

Correspondence Address: HARNESS, DICKEY & PIERCE, P.L.C., P.O. BOX 828, BLOOMFIELD HILLS, MI, 48303, US

(73) Assignee: Epson Imaging Devices Corporation

(21) Appl. No.: 12/077,598

(22) Filed: Mar. 19, 2008

(30) Foreign Application Priority Data
Mar. 20, 2007 (JP) 2007-071986
Nov. 30, 2007 (JP) 2007-309975

(51) Int. Cl. G09G 5/00

(52) U.S. Cl. 345/4; 345/694

(57) ABSTRACT

A dual image display device 1 according to an embodiment of the invention includes a crosstalk corrector 6 that corrects the grayscale of a sub pixel subject to correction based on the grayscale of an adjacent sub pixel. The crosstalk corrector 6 carries out corrections in K grayscale for N1 frames and corrections in K+1 grayscale for N−N1 frames within N frames where K being an integer, N being a positive integer of 2 or more, and N1 being a positive integer of less than N. Provided with the above-described configuration, the problem in that a dual image in which sub pixels of individual images for two visual directions are adjacent to each other in a gate line direction is liable to cause flicker in the gate line direction can be eliminated by an apparent crosstalk correction of less than one grayscale.

### BACKGROUND

1. Technical Field

The present invention relates to a dual image display device which displays two individual images respectively recognizable by visual directions on the same screen, and more particularly, to a dual image display device which provides a crosstalk correction of less than one grayscale.

2. Related Art

Liquid crystal display devices have been widely used as a display device installed on devices such as television receivers and information devices. Meanwhile, with the diversification of information devices and such in recent years, a dual image display device which displays a plurality of images overlaid on a single screen providing a first image on a first viewing area and a second image on a second viewing area has been disclosed; refer to JP-A-2005-258016.

Here, a dual image display device in related art will be described with reference to drawings. FIG. 18 is a cross sectional view of a related-art dual image display device. As shown in FIG. 18, a dual image display device 50 in the related art has a liquid crystal display panel 52 alternately disposed with a first sub pixel row 51a which displays a first image and a second sub pixel row 51b which displays a second image. Here, an individual element unit of red, green and blue, hereinafter called RGB, is called a sub pixel, and three sub pixels of RGB are collectively called a pixel. In the case of black and white, instead of color, a sub pixel is equal to a pixel. The first and second sub pixel rows 51a and 51b are composed of, for example, each sub pixel of a liquid crystal display device. Between pixels of the first and second sub pixel rows 51a and 51b, a black matrix 53 is formed. Over the liquid crystal display panel 52, via a transparent substrate, not shown, composed of a glass substrate and such of a thickness of G, disposed is a light blocking plate 54 composed of such as a metal or a resin having a light blocking function. The light blocking plate 54 has a light blocking section 55 and an opening section 56 being alternately extended in parallel with the first sub pixel row 51a and the second sub pixel row 51b.

Next, the scheme of how a dual image is displayed on the dual image display device 50 will be described. As shown in FIG. 18, in a first viewing area A which is separated from and to the left of the position C which is directly across from the liquid crystal display panel 52 and away from the surface of the light blocking plate 54 by a distance D, through the opening section 56 of the light blocking plate 54, a first image of the first sub pixel row 51a is provided. In this case, as a second image of the second sub pixel row 51b is blocked by the light blocking section 55 of the light blocking plate 54, the second image is not provided in the first viewing area A.

Meanwhile, in a second viewing area B which is separated from and to the left of the position C which is directly across from the liquid crystal display panel 52, through the opening section 56 of the light blocking plate 54, the second image of the second sub pixel row 51b is provided. In this case, as the first image of the first sub pixel row 51a is blocked by the light blocking section 55 of the light blocking plate 54, the first image is not provided in the second viewing area B. Consequently, a dual image is displayed providing the first image in the first viewing area A and providing the second image in the second viewing area B.

With the above-described dual image display device 50, when the dual image display device 50 is mounted, for example, in an automobile between the driver's seat and the passenger seat, as the viewing directions of the dual image display device 50 differ between the driver's seat and the passenger seat, an image from, for example, a car navigation device may be provided for the driver while another image is being provided for the passenger.

However, when there is a large potential difference between sub pixels next to each other in a liquid crystal display panel it is generally known that a change in brightness level occurs by the effect of potential difference. In a dual image display device, as sub pixels of images of different contents, for example, of a navigation device displaying a navigation image for the driver's seat direction and a DVD playback image for the passenger seat direction which are arranged next to each other, a large potential difference often occurs between pixels.

This potential difference appears, when a dual image is displayed, as crosstalk in a horizontal direction, i.e. a gate line direction. This phenomenon will be described with reference to FIG. 19. FIG. 19A presents schematic views of right and left input images and displayed images when a dual image is displayed. FIG. 19B is a schematic view showing the brightness level of each sub pixel of the dual image display device. In FIGS. 19A and 19B, the left side and right side are distinguished by surrounding with a triangle border for the first viewing position, i.e. the left side, and by surrounding with a square border for the second viewing position, i.e. the right side.

For example, as shown in FIG. 19A, when an input image of the left side has a black box in the middle surrounded by a solid mid-gray and an input image of the right side is entirely composed of a solid mid-gray and when the dual image is displayed, while the left side image is displayed in accordance with the input image, in the right side image, as crosstalk occurs, an area where the brightness has been changed corresponding to the black box image of the left side is observed.

In this case, the brightness level of each sub pixel is as shown in FIG. 19B. More specifically, when the dual image is displayed, while no changes in the brightness level occurs in each sub pixel in the area where input images of the left and right sides are of the same solid mid-gray, in the area where the left input image is solid black, as the difference between the voltages applied to a pixel electrode corresponding to the left side and to an adjacent pixel electrode corresponding to the right side becomes large, the brightness level of the sub pixel of the right side is, as indicated by an arrow in FIG. 19B, raised higher, or lowered depending on the image displayed, than the brightness level corresponding to the solid mid-gray image and, in the display area of the right side, the changes in brightness in a shape similar to the solid black area of the left side appear. This is the horizontal crosstalk when the dual image is displayed.

After various considerations given to eliminate the horizontal crosstalk in the dual image display device, the inventors have conceived of eliminating the horizontal crosstalk by creating a correction data table obtained from the amount of change in brightness caused by each difference in grayscales between adjacent sub pixels in advance through experiments and, when combining a dual image, by correcting sub pixel data subject to correction with the amount of change obtained from the correction data table according to the data of the sub pixel subject to correction and that of the immediate right sub pixel, and by applying this operation to the entire sub pixel data.

However, as the correction data obtained through experiments is not in integer numbers and as a liquid crystal panel driver cannot be driven without converting the data to integer numbers, there has been a problem in that a crosstalk correction is eventually provided in a unit of one grayscale.

The inventors have conceived of a method, by configuring the correction data table with a matrix of even-numbered grayscales omitting odd-numbered grayscales, in order to reduce a memory capacity, for calculating the correction data of odd-numbered grayscales from the correction data of even-numbered grayscales in integer numbers by interpolation. In this case, as the correction data of an odd-numbered grayscale is not in integer numbers, and needs to be converted to an integer number. As a result, there has been a problem in that the crosstalk correction is again provided in a unit of one grayscale.

With a regression analysis of experimental data, by a least-squares method, obtaining a linear equation of grayscale differences to approximate the correction data, the correction data may be calculated by the linear equation. While the correction data may be calculated by methods other than regression analysis, there has been a problem in that the correction data of any results may include decimal numbers.

As described above, as the experimental data, the interpolation of the correction data table, and the calculations of equations may include decimal numbers, there has been a problem in that the crosstalk correction is not in a unit of decimal numbers but in a unit of one grayscale.

### SUMMARY

An advantage of some aspects of the present invention is to further reduce crosstalk, despite the restriction in that a liquid crystal panel driver cannot be driven unless correction data is in integer numbers, by providing an apparent crosstalk correction of less than one grayscale.

According to a first aspect of the present invention, a dual image display device includes: a dual image synthesizer that outputs a dual image in which a display grayscale brightness of sub pixels is set and the sub pixels of individual images for two visual directions are adjacent to each other in a gate line direction, and a crosstalk corrector that corrects the grayscale of a sub pixel subject to correction based on the grayscale of an adjacent sub pixel. The crosstalk corrector carries out corrections in K grayscale for N1 frames and corrections in K+1 grayscale for N−N1 frames within N frames where K being an integer number, N being a positive integer number of 2 or more, and N1 being a positive integer number of less than N.

Consequently, as an apparent crosstalk correction of less than one grayscale can be carried out, the crosstalk is further reduced.

The dual image display device according to the present aspect of the invention may further include a data table storing the previously obtained correction data corresponding to grayscales between adjacent sub pixels in a gate line direction and the crosstalk corrector corrects based on the data table.

While in the related art only grayscale unit could be corrected even if the correction data of less than one grayscale is stored in the data table, correction of less than one grayscale can now be carried out by storing correction data of less than one grayscale in the correction data table.

According to the present aspect of the invention, the data table may be configured as a matrix of every other grayscale and store grayscale correction data in integers, and the crosstalk corrector may obtain correction data of skipped grayscales in every other grayscale from the data table by interpolation.

Consequently, despite the correction data calculated by interpolation not being in an integer number, as an apparent crosstalk correction of less than one grayscale can be carried out, the crosstalk is further reduced.

According to the present aspect of the invention, the crosstalk corrector may be defined as N=4. As the interpolation becomes an either average of two integer numbers or four integer numbers, all interpolated data are in the minimum unit of correction.

According to the present aspect of the invention, the crosstalk corrector may mix sub pixels of corrections in the K grayscale and sub pixels of corrections in the K+1 grayscale in the same frame of an image for the same visual direction.

Consequently, the flicker caused by the grayscale of an adjacent frame being different by one grayscale can be reduced.

According to the present aspect of the invention, an image for the same visual direction may be configured with a plurality of blocks composed of a predefined number of sub pixels as one block, array numbers from 1 to N that define an order of corrections in the K grayscale and corrections in the K+1 grayscale within N frames in one cycle may be set, and defining the number of the array numbers 1 to N assigned to the sub pixels in one block may be defined to be the same.

By the uniformly dispersed distribution of K+1 grayscale, the flicker can be reduced.

According to the present aspect of the invention, sub pixels of individual images for two visual directions may be arranged in a checkered pattern, and a set of red, green and blue sub pixels of an image for the same visual direction and in the same grayscale correction may be arranged as to line up in a V-shape for one individual image and in a Λ-shape for the other individual image.

By the pattern of a systematic distribution, the flicker can be reduced.

According to the present aspect of the invention, sub pixels of individual images for two visual directions may be arranged in a checkered pattern, and a set of red, green and blue sub pixels of an image for the same visual direction and in the same grayscale correction may be arranged as to line up diagonally in the same direction for two individual images.

By the pattern of a systematic distribution, the flicker can be reduced.

According to the present aspect of the invention, sub pixels of individual images for two visual directions may be arranged in a checkered pattern, and a set of red, green and blue sub pixels of the image for the same visual direction and in the same grayscale correction may be arranged as to line up diagonally in different directions from each other for two individual images.

By the pattern of a systematic distribution, the flicker can be reduced.

According to the present aspect of the invention, sub pixels of individual images for two visual directions may be arranged in a checkered pattern, and a set of red, green and blue sub pixels of the image for the same visual direction and in the same grayscale correction may be arranged as to line up diagonally one sub pixel apart.

By the pattern of a systematic distribution, the flicker can be reduced.

According to the present aspect of the invention, sub pixels of individual images for two visual directions may be arranged in a checkered pattern, and a set of red, green and blue sub pixels of the image for the same visual direction and in the same grayscale correction may be arranged as to be different for patterns of odd-numbered frames and for patterns of even-numbered frames.

By the pattern of a systematic distribution, the flicker can be reduced.

According to the present aspect of the invention, sub pixels of individual images for two visual directions may be arranged in a checkered pattern, and a set of red, green and blue sub pixels of the image for the same visual direction and in the same grayscale correction may be arranged as to line up diagonally for frames of either odd-numbered frames or even-numbered frames and as to line up in a V-shape or in a Λ-shape for the other frames.

By the pattern of a systematic distribution, the flicker can be reduced.

The dual image display device according to the present aspect of the invention may further include a selector that selects a pattern by an external input out of a plurality of patterns of mixed areas of corrections in the K grayscale and of corrections in the K+1 grayscale.

Consequently, a user of an electronic device can change flicker reduction patterns.

The dual image display device according to the present aspect of the invention may further include a selector to select a mode by an external input out of a plurality of modes with different values of the N.

Consequently, a user of an electronic device can change correction grayscale units.

According to the present aspect of the invention, the brightness of green sub pixels may be set higher than the brightness of red sub pixels and the brightness of blue sub pixels for the same grayscale, sub pixels of individual images for two visual directions may be arranged in a checkered pattern, and the sub pixels of an image for the same visual direction may be arranged as not to have any green sub pixels for the same visual direction in six directions of top left, top right, bottom left, bottom right, left and right with a green sub pixel being in the center.

By not arranging green sub pixels in high brightness close together, the flicker can be reduced.

According to the present aspect of the invention, sub pixels of individual images for two visual directions may be arranged in a checkered pattern, and the sub pixels of an image for the same visual direction may be arranged in a way that three sub pixels of the same color in K+1 grayscale carried out in K+1 grayscale for one frame within N frames do not move twice sequentially to adjacent pixels by change of frames.

Consequently, as the movement in K+1 grayscale by change of frames is avoided as much as possible, the flicker can be reduced.

According to another aspect of the invention, a dual image display device includes: a dual image synthesizer that outputs a dual image in which one pixel is composed of three sub pixels of red, green and blue, a display grayscale brightness of the sub pixels is set and sub pixels of individual images for two visual directions are adjacent to each other in a gate line direction, and a crosstalk corrector that corrects the grayscale of a sub pixel subject to correction based on the grayscale of an adjacent sub pixel. The crosstalk corrector carries out corrections in K grayscale for N1 frames and corrections in K+1 grayscale for N−N1 frames within N frames where K being an integer, N being a positive integer of 2 or more, and N1 being a positive integer of less than N. An image for the same visual direction is configured with a plurality of blocks each composed of M1 sub pixels. Array numbers from 1 to N that define an order of corrections in the K grayscale and corrections in the K+1 grayscale within N frames in one cycle are set. The number of array numbers 1 to N assigned to sub pixels in one block is defined to be the same. The brightness of green sub pixels is approximately L times higher than the brightness of red sub pixels and blue sub pixels for the same grayscale. The brightness of green sub pixels is calculated as approximately L times higher than the brightness of red and blue sub pixels, and a group whose total number of a sub pixel subject to judgment and its adjacent sub pixels is M2 is set within one block. If the corrections of the entire sub pixels in the one block are carried out by corrections in the K grayscale for N−1 frames and by corrections in the K+1 grayscale for one frame, a pattern is adopted for assigning the array numbers to one block in which an average brightness of one sub pixel in one group becomes approximately the same as an average brightness of one sub pixel in the block at least once within N frames for the entire sub pixels in the one block.

By the pattern in which an average brightness of a group is approximately the same as an average brightness of a block, the flicker can be reduced.

According to still another aspect of the invention, a dual image display device includes: a dual image synthesizer that outputs a dual image in which one pixel is composed of three sub pixels of red, green and blue, a display grayscale brightness of the sub pixels is set and sub pixels of individual images for two visual directions are adjacent to each other in a gate line direction, and a crosstalk corrector that corrects the grayscale of a sub pixel subject to correction based on the grayscale of an adjacent sub pixel. The crosstalk corrector carries out corrections in K grayscale for N1 frames and corrections in K+1 grayscale for N−N1 frames within N frames where K being an integer, N being a positive integer of 2 or more, and N1 being a positive integer of less than N. An image for the same visual direction is configured with a plurality of blocks each composed of M1 sub pixels. Array numbers from 1 to N that define an order of corrections in the K grayscale and corrections in the K+1 grayscale within N frames in one cycle are set. The number of array numbers 1 to N assigned to sub pixels in one block is defined to be the same. If the corrections of the entire sub pixels in the one block are carried out by corrections in the K grayscale for N−1 frames and by corrections in the K+1 grayscale for one frame, a pattern is adopted for assigning the array numbers to one block in which three frame orders of a sub pixel of the same color in a first adjacent pixel to the sub pixel subject to judgment to be in K+1 grayscale, of the sub pixel subject to judgment to be in K+1 grayscale, and of a sub pixel of the same color in a second adjacent pixel to the sub pixel subject to judgment to be in K+1 grayscale are not sequential for the entire sub pixels in the one block.

By the pattern with a small movement of high brightness, the flicker can be reduced.

### BRIEF DESCRIPTION OF THE DRAWINGS

The invention will be described with reference to the accompanying drawings, wherein like numbers reference like elements.

FIG. 1 is a block diagram showing principal sections of a dual image display device of an embodiment of the present invention.

FIG. 2 is a schematic view of pixel arrangements of a liquid crystal panel.

FIG. 3 is a schematic view of synthesis of individual images for two visual directions and arrangements of sub pixels in a checkered pattern.

FIG. 4 is schematic views of individual display images for two visual directions.

FIG. 5 is a chart showing a correction data table.

FIG. 6 is an illustration showing a method for interpolating grayscale correction data not stored in the correction data table.

FIG. 7 represents schematic views of four patterns for preventing flicker for the left visual direction.

FIG. 8 represents schematic views of four patterns for preventing flicker for the right visual direction.

FIG. 9 represents schematic views of four patterns for preventing flicker for the left and right visual directions.

FIG. 10 represents schematic views of pattern examples in 20th grayscale and 21st grayscale in flicker judgment.

FIG. 11 is a schematic view of the drawings in FIG. 10 represented in frame numbers.

FIG. 12 is a line graph of grayscale value vs. brightness showing high brightness of green.

FIG. 13 is a schematic view of a group for flicker judgment by unevenness in brightness.

FIG. 14 represents schematic views of an example liable to cause flicker by changes in brightness.

FIG. 15 is a schematic view of the drawings in FIG. 14 represented in frame numbers.

FIG. 16 is a schematic view of sub pixel positions of the upper right and lower right of a sub pixel subject to judgment by changes in brightness.

FIG. 17 is a schematic view of a calculation result of points.

FIG. 18 is a cross sectional view of a liquid crystal dual image display device in related art.

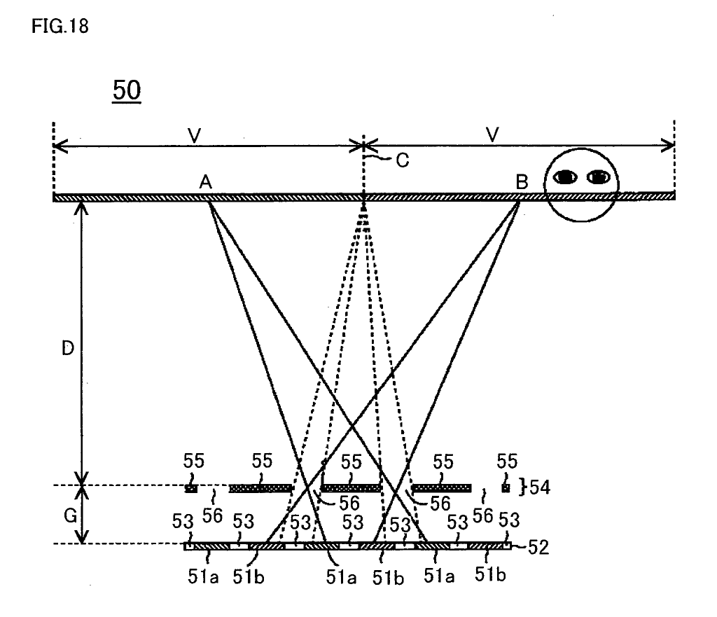

FIG. 19A represents schematic views of right and left input images and displayed images when a dual image is displayed, and FIG. 19B is a schematic view of a brightness level of each sub pixel of the liquid crystal dual image display device.

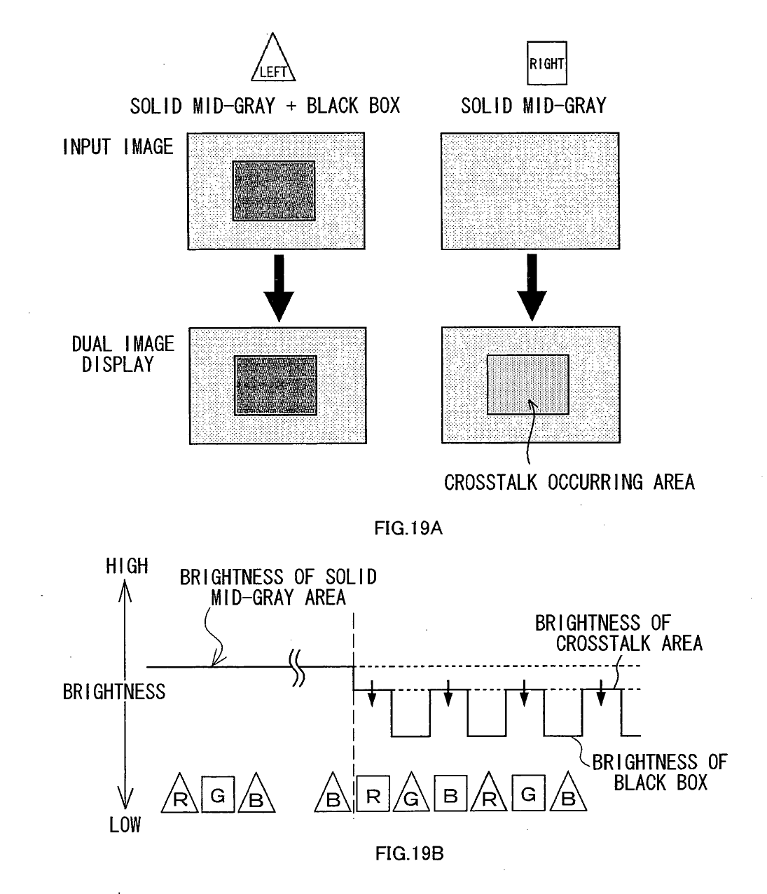

### DESCRIPTION OF EXEMPLARY EMBODIMENTS

Here, specific instances of preferred embodiments of the present invention will be described with reference to drawings. However, the embodiments described hereafter are examples of a dual image display device to embody technical ideas of the invention, not intended to limit the invention to these specific instances, and are equally applicable to those other embodiments within the spirit and scope of the invention as defined in the appended claims.

### First Embodiment

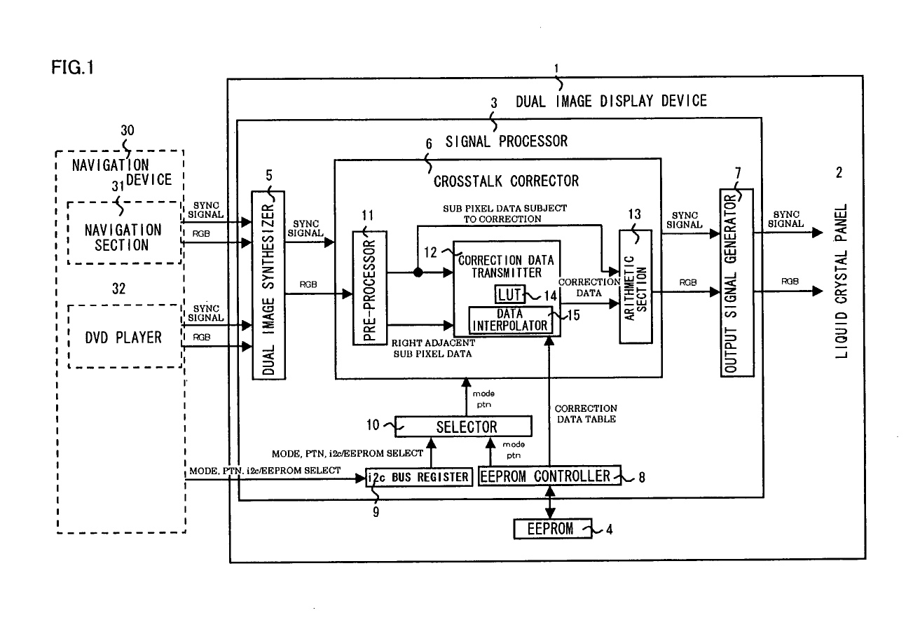

FIG. 1 is a block diagram showing principal sections of a dual image display device of a first embodiment of the invention. A solid line box in FIG. 1 indicates a dual image display device 1 and a broken line box indicates a navigation device 30 where the dual image display device 1 is incorporated.

The dual image display device 1 has a liquid crystal panel 2, a signal processor 3 which processes two source images, i.e. a navigation image and a DVD image, from the navigation device 30 for displaying a dual image and outputs to the liquid crystal panel 2, and an EEPROM 4 which stores various types of data, such as a later described correction data table, mode and ptn, required for operations of the signal processor 3.

The signal processor 3 has a dual image synthesizer 5 which synthesizes two images, a crosstalk corrector 6 which corrects crosstalk an output signal generator 7 which controls polarities and timings of the signal corrected by the crosstalk corrector 6 to be displayed on the liquid crystal panel, an EEPROM controller 8 which controls input and output of the EEPROM 4, an i2c bus register 9 which delivers signals from the navigation device 30 to the crosstalk corrector 6, and a selector 10 which selects either output of the EEPROM controller 8 or the i2c bus register 9.

The crosstalk corrector 6 has a pre-processor 11, a correction data transmitter 12 and an arithmetic section 13. The pre-processor 11 sends required data from an image signal of the dual image synthesizer 5 to the pre-processor 11 and to the correction data transmitter 12. The correction data transmitter 12 has a look up table (LUT) 14 storing the correction data table from the EEPROM controller 8 and a data interpolator 15 which interpolates for the data not stored in the LUT 14, and obtains correction data. The arithmetic section 13 adds the correction data from the correction data transmitter 12 to images from the pre-processor 11.

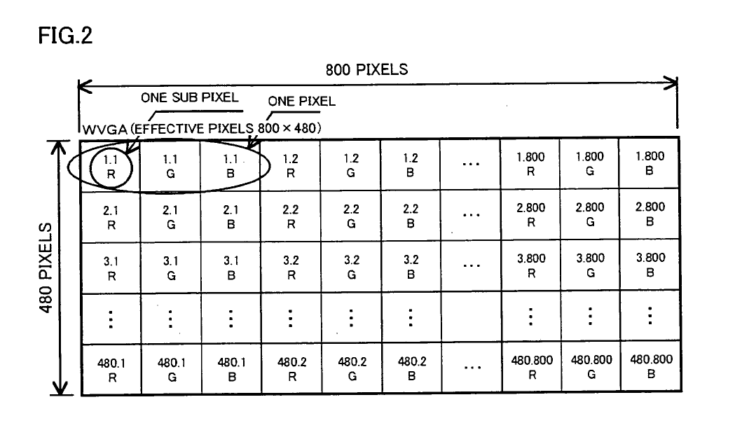

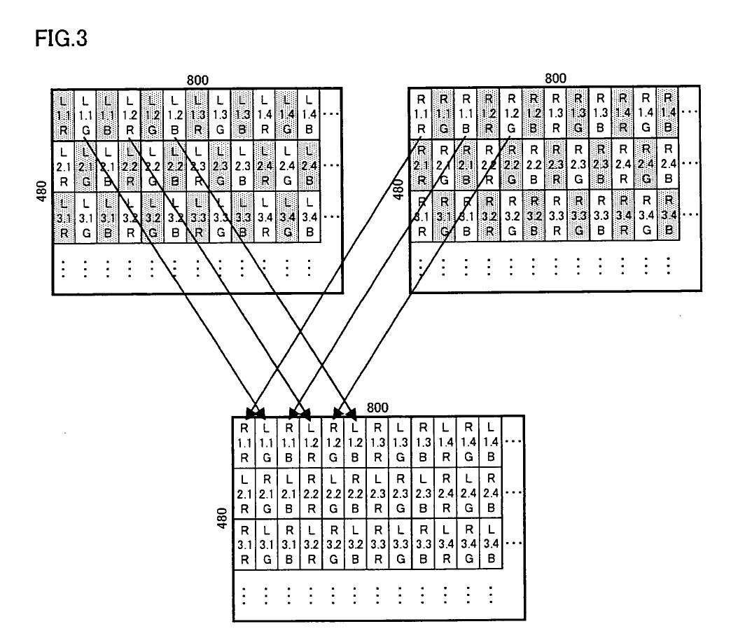

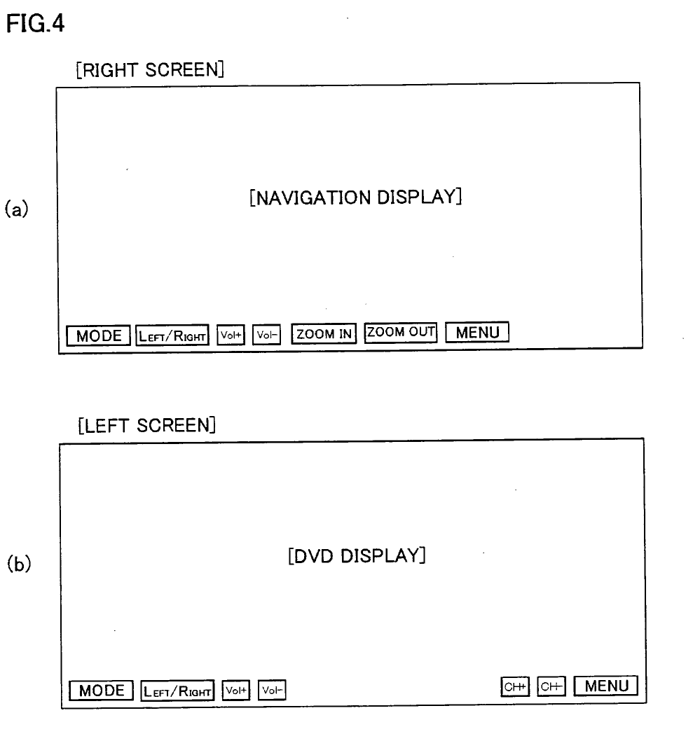

FIG. 2 is a schematic view of pixels of the liquid crystal panel 2. The liquid crystal panel 2 is of a color WVGA type having 800 pixels in a gate line direction, i.e. a horizontal direction, and 480 pixels in a source line direction, i.e. a vertical direction. One pixel is composed of three sub pixels of RGB. As shown in FIG. 3, the liquid crystal panel 2 has a liquid crystal shutter of light blocking pattern for sub pixels in a checkered pattern, i.e. a black and white pattern for checkerboards. Consequently, one side of the sub pixels in a checkered pattern is visible only from the right direction, i.e. a driver's seat direction in Japan, and the other side is visible only from the left direction, i.e. a passenger seat direction in Japan (refer to FIG. 4). The sub pixel is of 6-bit and the brightness of RGB becomes grayscales of 64 shades as 6 powers of 2. A driving control of the brightness of the liquid crystal panel 2 is in a unit of one grayscale. More specifically, the grayscales other than integer numbers cannot be specified. A cycle of one screen which contains 800 pixels by 480 pixels, i.e. specifically a frame cycle, is at 60 Hz.

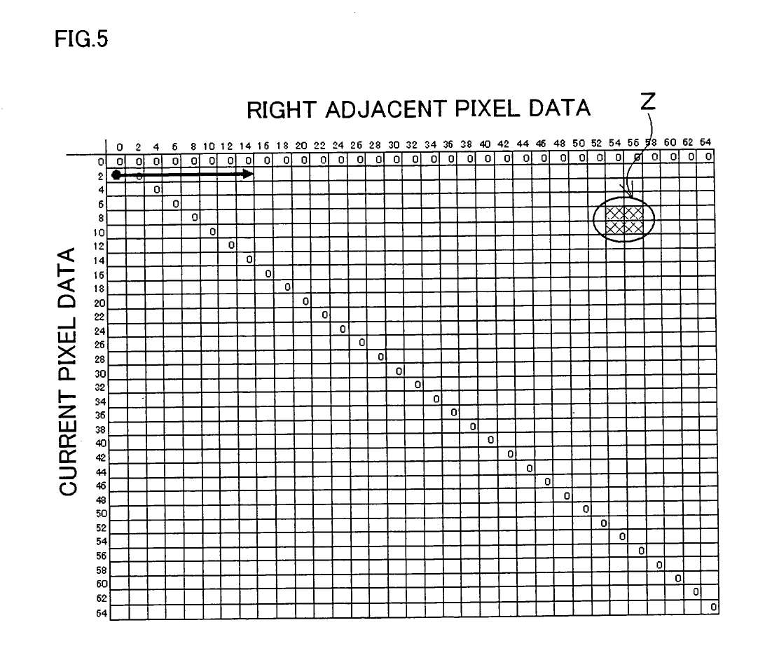

FIG. 5 illustrates the correction data table. While 64 shades of grayscales are defined as from 0th grayscale to 63rd grayscale, the correction data table is configured with the sub pixel data subject to correction and the data of the immediate right sub pixel as a matrix of 33 by 33 with a matrix of 32 by 32 as (64/2)×(64/2) respectively corresponding to even-numbered grayscales, i.e. every other grayscale of 0th grayscale, 2nd grayscale, 4th grayscale, and so on to 62nd grayscale and, in addition, with the correction data of a dummy auxiliary grayscale, i.e. 64th grayscale. This is to calculate the last grayscale, i.e. 63rd grayscale, by a later described interpolation.

In the matrix, the correction data which has been experimentally defined from the sub pixel data subject to correction and the data of the immediate right sub pixel as 4-bit data of a grayscale in integer numbers, for example as shown in Table 1, defining bit 3 as a sign bit and three bits of bit 2 to bit 0 as the correction data, and in the values of −7 to 0 to +7 are respectively stored. As the minimum unit of grayscale to drive the liquid crystal panel 2 is one grayscale, the experimental data is rounded to an integer number and stored.

TABLE 1
Correction value in the correction data table

| | | | |
|---|---|---|---|
| Bit 3 | Bit 2 | Bit 1 | Bit 0 |

| | |
|---|---|
| Sign | Correction value (0 to 7) |

In FIG. 5, the boxes marked as 0 are where the correction is not required as no horizontal crosstalk occurs as the sub pixel data subject to correction and the data of the immediate right sub pixel are of the same value, and where the correction is not required as no horizontal crosstalk occurs regardless of the data of the immediate right sub pixel as the sub pixel data subject to correction is of either the minimum value of 0 or the maximum value of 63. In FIG. 5, while correction data are all omitted, except for those where the correction is not required as no horizontal crosstalk occurs, any one of the values in integers from −7 to 0 to +7 is held in each box.

The EEPROM 4 stores the data other than those marked as 0 in FIG. 5, more specifically 992 pieces of 4-bit data, i.e. (33×33−33×3+2)×4-bit=992×4-bit. The data experimentally defined previously and stored in the EEPROM 4 is, when a power switch is turned on, loaded from the EEPROM 4 to the LUT 14 composed of a random access memory (RAM) and spread out as shown in FIG. 5.

The dual image display device 1 of the present embodiment is provided with three modes: one grayscale unit crosstalk correction mode, one-half grayscale unit crosstalk correction mode and one-quarter grayscale unit crosstalk correction mode. The selection of these is made, as shown in Table 2, based on mode data in 2-bit, and the mode data is stored in the EEPROM 4. The mode data can also be entered from the navigation device 30 to the dual image display device 1, and which mode data to use is selected by an i2c/EEPROM select signal from the navigation device 30.

TABLE 2

| | |
|---|---|
| mode = LL/HH | One grayscale unit correction mode |
| mode = HL | ½ grayscale unit correction mode |
| mode = LH | ¼ grayscale unit correction mode |

First, the quarter grayscale unit correction mode, i.e. mode=LH, is described.

As shown in FIG. 3, the dual image synthesizer 5 sorts out a navigation image of 800 pixels by 480 pixels fed from a navigation section 31 of the navigation device 30 and an image of 800 pixels by 480 pixels fed from a DVD player 32 in a checkered pattern of sub pixels, and synthesizes a single image of 800 pixels by 480 pixels.

The pre-processor 11 of the crosstalk corrector 6, based on the synthesized image fed from the dual image synthesizer 5, outputs the sub pixel data subject to correction to the correction data transmitter 12 and to the arithmetic section 13 and outputs the data of the immediate right sub pixel to the correction data transmitter 12.

In the correction data transmitter 12, at the same time as the power is supplied to the dual image display device 1, the correction data table stored in the EEPROM 4 is loaded to the LUT 14 via the EEPROM controller 8.

The correction data transmitter 12 reads, based on the grayscale of the sub pixel subject to correction and the data of the immediate right sub pixel, the corresponding correction data from the LUT 14. In this case, as the correction data table is in steps of every other grayscale, for values between steps, i.e. an odd-numbered grayscale, the correction data is interpolated by the data interpolator 15.

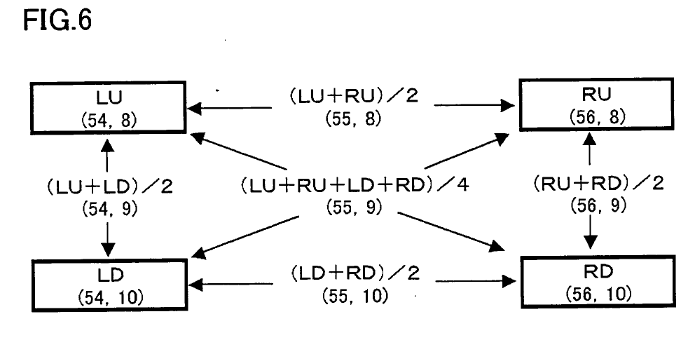

The operation of the data interpolator 15 of the correction data transmitter 12 is described as follows. When the data of four boxes in Z-section in FIG. 5 are defined, for example, as LU, RU, LD and RD as shown in FIG. 6, the correction data corresponding to the data between LU and RU is obtained by the equation of (LU+RU)/2, the correction data corresponding to the data between LU and LD is obtained by the equation of (LU+LD)/2, the correction data corresponding to the data between RU and RD is obtained by the equation of (RU+RD)/2, the correction data corresponding to the data between LD and RD is obtained by the equation of (LD+RD)/2, and the correction data corresponding to the data between LU and RD is obtained by the equation of (LU+RU+LD+RD)/4. While the entire data for all grayscales may be spread out to the LUT 14, adopting the above-described configuration makes the amount of data stored in the EEPROM 4 small. Further, as the size of the LUT 14 being small makes accessing the LUT 14 fast and as the interpolation itself is carried out simple and fast, the dual image display device of a smooth display and of an excellent display image quality is obtained.

In the above-described interpolation, as the addition of LU, RU, LD and RD is divided by 2 or 4, the correction data obtained by the interpolation becomes a grayscale of one-quarter unit. However, as the liquid crystal panel must be driven by grayscales in integer numbers, the present embodiment mixes corrections in K grayscale and corrections in K+1 grayscale in a cycle of four frames. When all sub pixels in one frame are set to K+1 grayscale, it is more likely to cause flicker. Therefore, as shown in Table 3, the sub pixels to be corrected in K+1 grayscale are separated in four kinds of arrangements as arrays 1, 2, 3 and 4, and distributed over four frames.

While the correction data stored in the above-mentioned correction data table of the embodiment is in integer numbers of 4-bit, the values including decimal numbers may be stored. In this case, not only for the interpolated odd-numbered grayscales but also for the even-numbered grayscales, a crosstalk correction of less than one grayscale can be carried out.

TABLE 3

| Correction | 1st frame | | | | 2nd frame | | | | 3rd frame | | | | 4th frame | | | |
|---|---|---|---|---|---|---|---|---|---|---|---|---|---|---|---|---|
| amount below | correction amount | | | | correction amount | | | | correction amount | | | | correction amount | | | |
| decimal point | Array | Array | Array | Array | Array | Array | Array | Array | Array | Array | Array | Array | Array | Array | Array | Array |
| [d] | 1 | 2 | 3 | 4 | 1 | 2 | 3 | 4 | 1 | 2 | 3 | 4 | 1 | 2 | 3 | 4 |
| 0 | 0 | 0 | 0 | 0 | 0 | 0 | 0 | 0 | 0 | 0 | 0 | 0 | 0 | 0 | 0 | 0 |
| 0.25 | 1 | 0 | 0 | 0 | 0 | 1 | 0 | 0 | 0 | 0 | 1 | 0 | 0 | 0 | 0 | 1 |
| 0.5 | 1 | 0 | 1 | 0 | 0 | 1 | 0 | 1 | 1 | 0 | 1 | 0 | 0 | 1 | 0 | 1 |
| 0.75 | 0 | 1 | 1 | 1 | 1 | 0 | 1 | 1 | 1 | 1 | 0 | 1 | 1 | 1 | 1 | 0 |

For example, when the interpolated correction is in 1.25 grayscale, for the first frame out of four frames, i.e. (4n−3)-th frame, while the correction in 2nd grayscale is carried out on the sub pixels of the array 1, the correction in 1st grayscale is carried out on those arrays of 2, 3 and 4. For the second frame out of four frames, i.e. (4n−2)-th frame, while the correction in 2nd grayscale is carried out on the sub pixels of the array 2, the correction in 1st grayscale is carried out on those arrays of 1, 3 and 4. For the third frame out of four frames, i.e. (4n−1)-th frame, while the correction in 2nd grayscale is carried out on the sub pixels of the array 3, the correction in 1st grayscale is carried out on those arrays of 1, 2 and 4. For the fourth frame out of four frames, i.e. 4n-th frame, while the correction in 2nd grayscale is carried out on the sub pixels of the array 4, the correction in 1st grayscale is carried out on those arrays of 1, 2 and 3.

Consequently, the correction order of four frames becomes as 1, 0, 0 and 0 for the array 1, as 0, 1, 0 and 0 for the array 2, as 0, 1 and 0 for the array 3, and as 0, 0, 0 and 1 for the array 4, and each timing of corrections in K+1 grayscale differs from the others. For the grayscale whose correction amount below decimal point is 0.5, the timings of corrections in K+1 grayscale for arrays 1 and 3 and arrays 2 and 4 become the same.

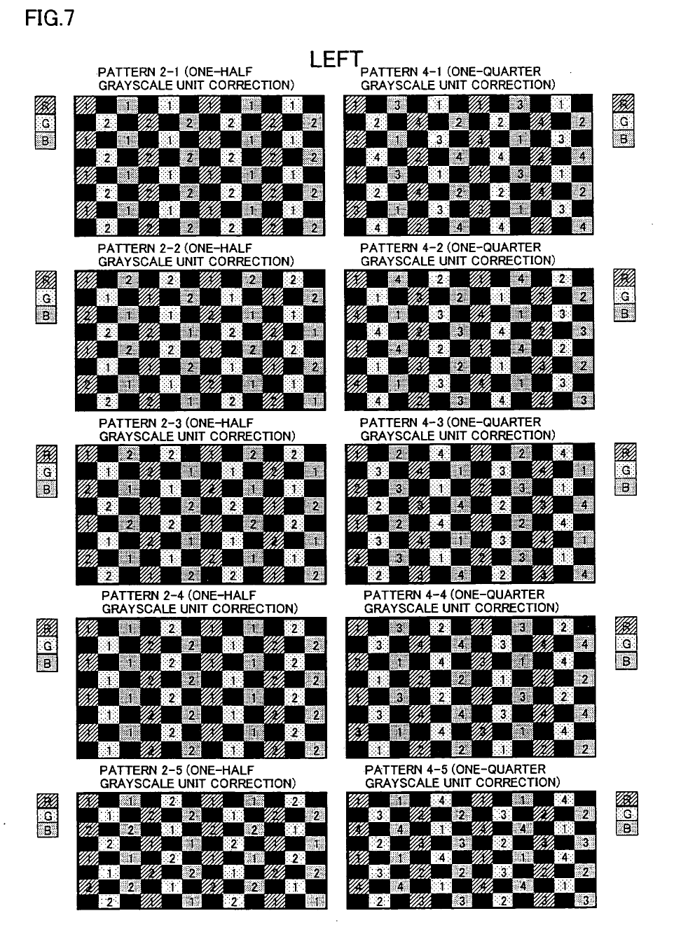

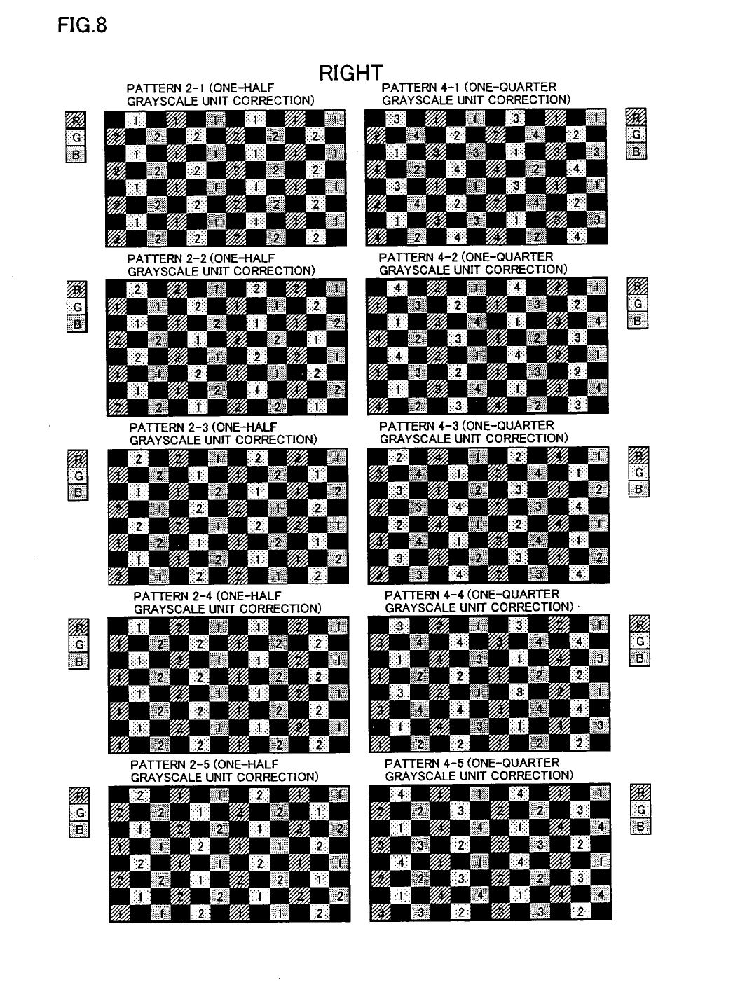

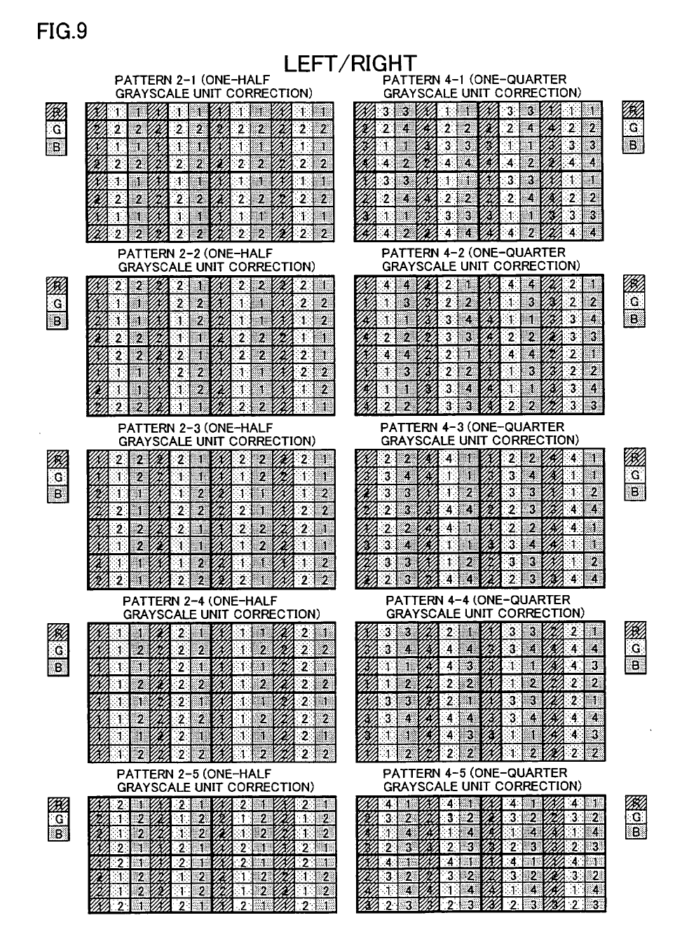

FIGS. 7, 8 and 9 show four patterns each of arrangements for arrays 1, 2, 3 and 4. FIG. 7 represents images, i.e. 12 sub pixels by 8 sub pixels, of a left visual direction, FIG. 8 represents those of a right visual direction, and FIG. 9 represents those of the left and right combined. FIGS. 7, 8 and 9 show four patterns of one-half grayscale unit corrections on the left side and four patterns of one-quarter grayscale unit corrections on the right. The patterns for the one-half grayscale unit corrections are made by changing the pattern of the array 3 of the one-quarter grayscale unit corrections to the same as that of the array 1 and by changing the pattern of the array 4 to the same as that of the array 2, with their setting patterns being the same. In FIGS. 7 and 8, in the pattern 2-1 and pattern 4-1, a set of RGB is lined up diagonally one sub pixel apart in a right down direction in the array 1 and array 3 and a set of RGB is lined up diagonally one sub pixel apart in a right up direction in the array 2 and array 4. In the pattern 2-1, a set of RGB is lined up horizontally in the arrays 1, 2, 3 and 4. In the pattern 2-2 and pattern 4-2, a set of RGB is lined up diagonally in a right down direction in the arrays 1, 2, 3 and 4. In the pattern 2-3 and pattern 4-3, a set of RGB is lined up diagonally in a right up direction in the array 1 and array 4 and a set of RGB is lined up diagonally in a right down direction in the array 2 and array 3. In the pattern 2-3, a set of RGB is lined up in a V-shape and in a Λ-shape in the arrays 1, 2, 3 and 4. In the pattern 2-4 and pattern 4-4, a set of RGB is lined up diagonally in a right up direction in the array 1 and array 3 and a set of RGB is lined up in a V-shape in the array 2 and array 4.

As the frame cycle is 60 Hz, by mixing corrections in K grayscale and corrections in K+1 grayscale in cycles of N frames, where N is a positive integer number of 2 or more, an apparent correction, by a retinal afterimage effect, of less than one grayscale unit can be carried out.

As the arrangement of sub pixels for corrections in K+1 grayscale is separated in four kinds of the arrays 1, 2, 3 and 4 and distributed over four frames, in other words, as corrections in K grayscale and corrections in K+1 grayscale are mixed in one frame, an occurrence of flicker can be reduced. As the arrangement patterns of the respective arrays 1, 2, 3 and 4 are, as shown in FIGS. 7, 8 and 9, evenly distributed in various systematic patterns, the occurrence of flicker can further be reduced. While the above-mentioned light blocking pattern is in a checkered pattern, various patterns such as a stripe pattern, i.e. vertical stripes, may be applied to the present invention.

As shown in Table 4, four patterns in FIGS. 7, 8 and 9 are selected by ptn in 2-bit. As for the ptn, as similar to the mode, ptn data is stored in the EEPROM 4. The ptn data can also be entered to the dual image display device 1 from the navigation device 30, and which ptn data to use is selected by the i2c/EEPROM select signal from the navigation device 30.

TABLE 4

| | |
|---|---|
| ptn = LL | Pattern 2-1, pattern 4-1 |
| ptn = LH | Pattern 2-2, pattern 4-2 |
| ptn = HL | Pattern 2-3, pattern 4-3 |
| ptn = HH | Pattern 2-4, pattern 4-4 |

Table 5 shows correction data to correct sub pixels subject to correction. The correction data is in 4-bit, i.e. h[3:0], and differs by mode. As the above-mentioned example is of corrections in one-quarter grayscale unit, i.e. mode=LH, the correction range becomes from −1.75 grayscales to +1.75 grayscales and is narrow. However, increasing the number of bit in h[3:0] easily widens the correction range.

TABLE 5

| | | | | Correction value | | | | | | |
|---|---|---|---|---|---|---|---|---|---|---|
| | | | | | mode = HL | | | mode = LH | | |
| h[3:0] | | | | mode = LL/HH | K | K + 1 | Ave. | K | K + 1 | Ave. |
| 1 | 1 | 1 | 1 | −7 | −4 | −3 | −3.5 | −1 | −2 (3 | −1.75 |
| | | | | | | | | (1 time) | times) | |
| 1 | 1 | 1 | 0 | −6 | −3 | −3 | −3.0 | −1 (2 | −2 (2 | −1.50 |
| | | | | | | | | times) | times) | |
| 1 | 1 | 0 | 1 | −5 | −3 | −2 | −2.5 | −1 (3 | −2 | −1.25 |
| | | | | | | | | times) | (1 time) | |
| 1 | 1 | 0 | 0 | −4 | −2 | −2 | −2.0 | −1 | −1 | −1.00 |
| 1 | 0 | 1 | 1 | −3 | −2 | −1 | −1.5 | 0 (1 time) | −1 | −0.75 |
| | | | | | | | | | (3 times) | |
| 1 | 0 | 1 | 0 | −2 | −1 | −1 | −1.0 | 0 (2 times) | −1 | −0.50 |
| | | | | | | | | | (2 times) | |
| 1 | 0 | 0 | 1 | −1 | −1 | 0 | −0.5 | 0 (3 times) | −1 (1 time) | −0.25 |
| 1 | 0 | 0 | 0 | 0 | 0 | 0 | 0.0 | 0 | 0 | 0.00 |
| 0 | 0 | 0 | 0 | 0 | 0 | 0 | 0.0 | 0 | 0 | 0.00 |
| 0 | 0 | 0 | 1 | 1 | 0 | 1 | 0.5 | 0 (3 times) | 1 (1 time) | 0.25 |
| 0 | 0 | 1 | 0 | 2 | 1 | 1 | 1.0 | 0 (2 times) | 1 (2 times) | 0.50 |
| 0 | 0 | 1 | 1 | 3 | 1 | 2 | 1.5 | 0 (1 time) | 1 (3 times) | 0.75 |
| 0 | 1 | 0 | 0 | 4 | 2 | 2 | 2.0 | 1 | 1 | 1.00 |
| 0 | 1 | 0 | 1 | 5 | 2 | 3 | 2.5 | 1 (3 times) | 2 (1 time) | 1.25 |
| 0 | 1 | 1 | 0 | 6 | 3 | 3 | 3.0 | 1 (2 times) | 2 (2 times) | 1.50 |
| 0 | 1 | 1 | 1 | 7 | 3 | 4 | 3.5 | 1 (1 time) | 2 (3 times) | 1.75 |

As described above, the correction data transmitter 12 outputs, according to the mode and pattern specified by the mode data and ptn data and based on the correction data table, the correction data to the arithmetic section 13 in every frame. The arithmetic section 13 obtains the corrected sub pixel data by adding the correction data delivered from the correction data transmitter 12 to the sub pixel data subject to correction delivered from the pre-processor 11, and delivers the corrected sub pixel data to the output signal generator 7. The output signal generator 7 controls polarities and timings of the signal corrected by the crosstalk corrector 6 as to be displayed on the liquid crystal panel 2 and outputs the corrected signal to the liquid crystal panel 2. The data correction of sub pixels described above is sequentially carried out, for the entire sub pixel data, one sub pixel at a time rightward.

In the above-mentioned embodiment, as the correction data table is in every other grayscale, the one-quarter grayscale unit correction mode is adopted according to the unit of correction data. While the one-half grayscale unit correction mode and one grayscale unit correction mode have a disadvantage in that the crosstalk correction is inferior to that of the one-quarter grayscale unit correction mode, they are nevertheless in the level of commercialization. As shown in Table 5, the one-half grayscale unit correction mode and one grayscale unit correction mode have an advantage in that the correction range is wide. Therefore, the present embodiment is provided with the i2c bus register for a user to select the mode. For the flicker reduction patterns, the i2c bus register is also provided for the user to select.

### Second Embodiment

While in the first embodiment of the invention, four kinds of systematic patterns in K grayscale and in K+1 grayscale are mixed in one frame, in a second embodiment, the way to quantify the judgment of flicker based on factors of flicker is conceived and, based on this value, a pattern that is not liable to cause flicker is created.

Patterns shown in FIGS. 7 to 9 are arranged with a repeating block of six sub pixels in a horizontal direction by four sub pixels in a vertical direction. As mentioned above, usually, a predefined block unit of sub pixels is repeatedly arranged. In the second embodiment, the sub pixels of six in the horizontal direction by four in the vertical direction are to be arranged as one block and quantified.

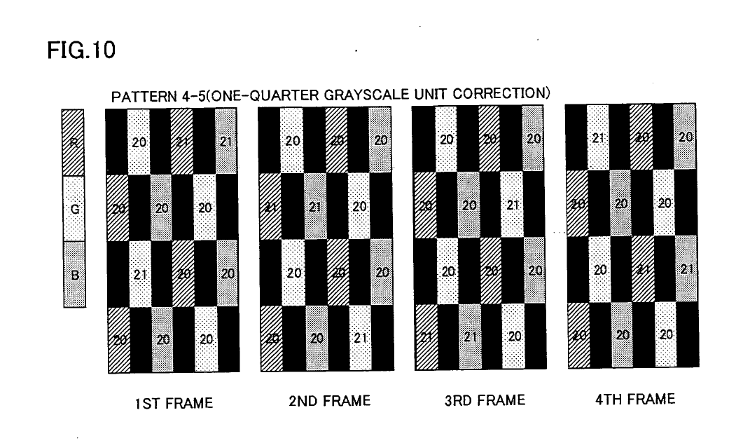

As shown in FIG. 10, in a dual image display device of a checkered pattern, by carrying out three frames in 20th grayscale and one frame in 21st grayscale, an example of carrying out an apparent 20.25 grayscale of an image for a right visual direction will be described. In FIG. 10, a right up diagonal lined area indicates red (hereinafter called R), an approximately 10% gray shaded area, i.e. a lighter shade, indicates green (hereinafter called G) and an approximately 20% gray shaded area, i.e. a darker shade, indicates blue (hereinafter called B), and the numbers 20 and 21 indicate grayscale values. The pattern number in FIG. 10 is defined as 4-5. As one pixel is formed in a square shape, a sub pixel becomes in a rectangular shape.

Table 6 is a chart of assigned orders of 20th grayscale and 21st grayscale in four frames per one cycle. There are four kinds of assignments and these four kinds are numbered as array numbers. The array number H means 21st grayscale is carried out in H-th frame of one cycle. For example, with the array number 2, 21st grayscale is carried out in 2nd frame and 20th grayscale is carried out in 1st, 3rd and 4th frames.

TABLE 6

| | |
|---|---|
| Array | Brightness |

| number | 1st frame | 2nd frame | 3rd frame | 4th frame |
|---|---|---|---|---|
| 1 | 21 | 20 | 20 | 20 |
| 2 | 20 | 21 | 20 | 20 |
| 3 | 20 | 20 | 21 | 20 |
| 4 | 20 | 20 | 20 | 21 |

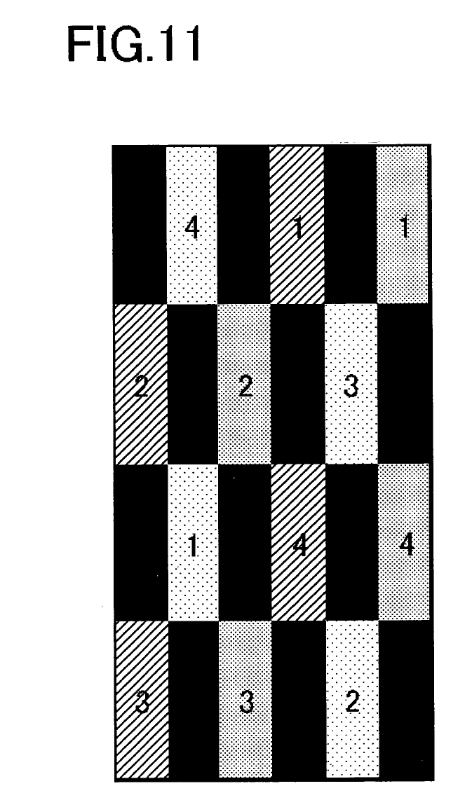

FIG. 11 is a schematic view showing four drawings by frames in FIG. 10 in one drawing represented by the array numbers 1 to 4.

As for factors of flicker, unevenness of brightness within a frame and changes in brightness within a frame are cited. When brightness is evenly distributed, not one-sided, it is not likely to cause flicker. When a sub pixel of high brightness is not moved in accordance with change of frames, as in animation, it is not likely to cause flicker.

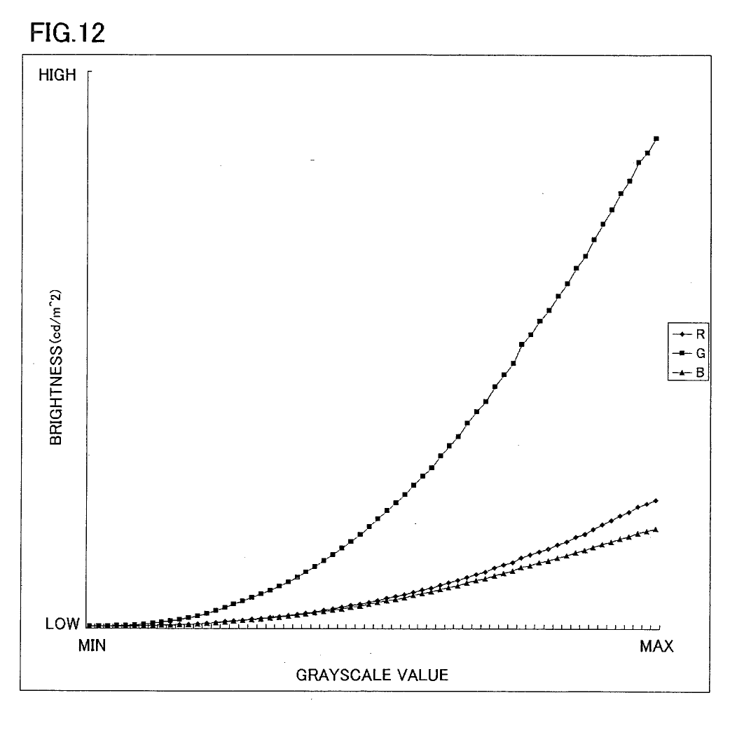

First, an evenness of brightness is described. In an image for the right visual direction configured with a block of six sub pixels in the horizontal direction by four sub pixels in the vertical direction, there are nine sub pixels in 20th grayscale and three sub pixels in 21st grayscale. In one block, there are four green sub pixels. As shown in a grayscale vs. brightness curve in FIG. 12, for the same grayscale, the brightness of red and blue are approximately the same and the brightness of green is approximately four times more than that of red and blue. As green is the color that is more sensitive to human eyes, as to make a liquid crystal panel appearing to be brighter, the brightness of green is set higher than that of red and blue for the same grayscale.

A change in brightness up by one grayscale is calculated here. When extracting sub pixels that become brighter than that of 20th grayscale in one frame of one block of the image for the right visual direction, there is one sub pixel each of RGB in 21st grayscale. As the brightness of R and B for the same grayscale is approximately the same and that of G is approximately four times brighter than that of R and B, when the level in brightness difference between 20th grayscale and 21st grayscale for R is defined as 1, that for one frame of one block is up by 6 levels as 1+4+1=6. Since the number of sub pixels in one block for the right visual direction is 12, the sub pixels and G in 21st grayscale need to be arranged as to have an average of 0.5 levels up per one sub pixel.

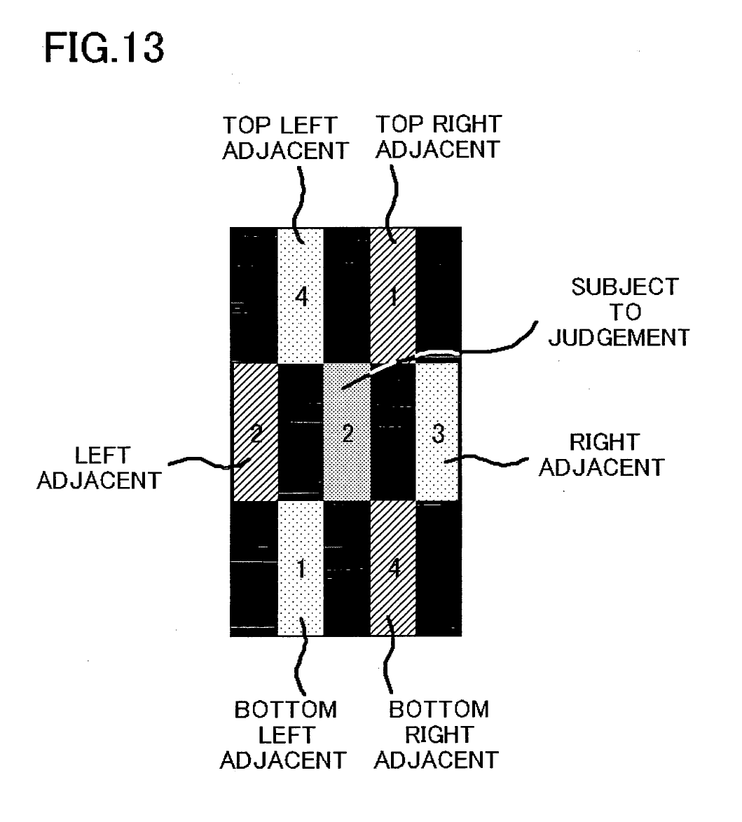

A specific method will now be explained. As shown in FIG. 13, a total of 7 sub pixels of one base sub pixel and six adjacent sub pixels of upper left, upper right, left, right, lower left and lower right are defined as one group. The sub pixel is in a rectangular shape as three RGB sub pixels forming a square. Therefore, as the sub pixels above and below the base sub pixel are apart from the base sub pixel they are not included in the group. As the number of sub pixels in one group is 7, it is ideal that the brightness of one group is to be 3.5 levels up as 0.5 levels×7=3.5 levels. However, as the level total must be in integer numbers, by rounding, an ideal level is defined as 4 levels.

Table 7 is a chart of calculated level of difference in brightness for the drawing in FIG. 13.

TABLE 7

| | 1st frame | 2nd frame | 3rd frame | 4th frame |
|---|---|---|---|---|
| Subject to judgment | 0 | 1 | 0 | 0 |
| B-2 | | | | |
| 1st adjacent G-4 | 0 | 0 | 0 | 4 |
| 2nd adjacent R-1 | 1 | 0 | 0 | 0 |
| 3rd adjacent R-2 | 0 | 1 | 0 | 0 |
| 4th adjacent G-3 | 0 | 0 | 4 | 0 |
| 5th adjacent G-1 | 4 | 0 | 0 | 0 |
| 6th adjacent R-4 | 0 | 0 | 0 | 1 |
| Brightness difference | 5 | 2 | 4 | 5 |
| Point | 0 | 0 | 1 | 0 |

In this calculation method, for the base sub pixel and six adjacent sub pixels, when their array number is not equal to the current frame number in one cycle, as they are in 20th grayscale and there is no difference in brightness, the level is defined as 0 levels. When their array number is equal to the current frame number, the levels are defined as 1 level for red and blue and 4 levels for green. The levels for each frame of 1st frame, 2nd frame, 3rd frame and 4th frame are added up, and 1 point is given when their respective total is in 4 levels and 0 point is given when other than 4 levels.

Forty eight pieces, as 4 frames by 12 sub pixels, of points, i.e. evenness of brightness, for one block are obtained. The larger the total point is, the less likely to cause flicker by unevenness of brightness.

As just described, by setting a group composed of a sub pixel subject to judgment and its adjacent sub pixels, when an average brightness per one sub pixel of the group is approximately the same as that of one sub pixel of the block, it is defined to add a point. The points for all sub pixels within one block are obtained and the points for four frames are further obtained and summed. Consequently, as it is quantified based on the average brightness, the flicker by unevenness in brightness can be judged. As the higher brightness of green is taken into account, a highly accurate quantification can be carried out. By the judgment of this quantification, a pattern of reduced flicker can be obtained.

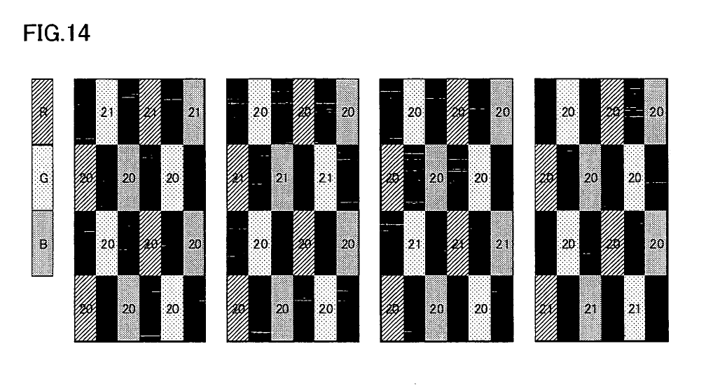

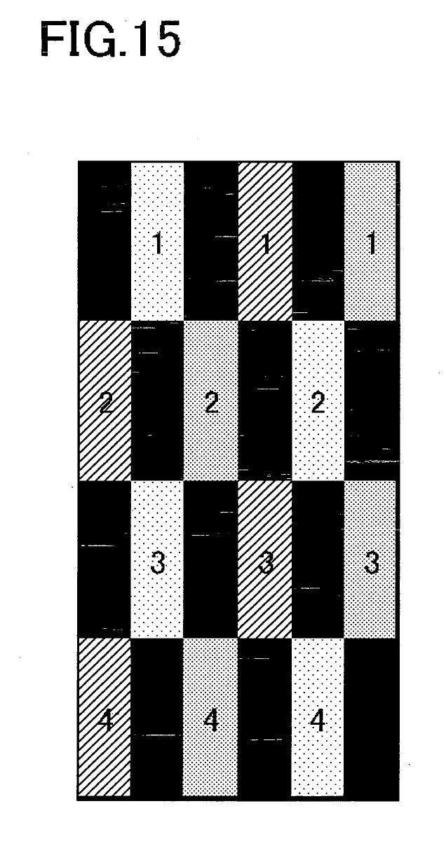

Next, changes in brightness are described. FIGS. 14 and 15 show an example of a bad pattern. In FIGS. 14 and 15, as the frame number of the same color is increased by one downwards, it seems to wave downwards in accordance with change of frames.

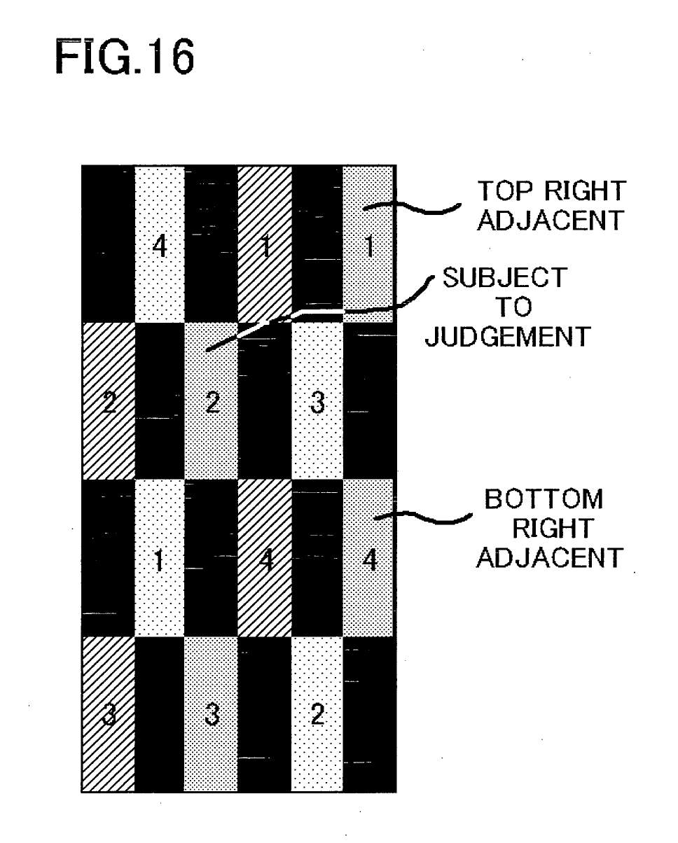

When array numbers of a sub pixel of the same color in a top right adjacent pixel and of a sub pixel of the same color in a bottom right adjacent pixel (refer to the drawing in FIG. 16 for their positions) and an array number of a sub pixel subject to judgment are in sequence of three while the array number of the sub pixel subject to judgment being in the middle, a point is defined as 0, and when the three numbers are not sequential, as it is less likely to cause flicker, the point is defined as 1. Here, the adjacent pixels mean, in the array in FIG. 2, eight pixels on the left, right, top and bottom and diagonally on the top left, top right, bottom left and bottom right. The three sequential numbers may be in ascending order or in descending order, and numbers 1 and 4 are considered sequential.

Twelve pieces of points, i.e. changes in brightness, for 12 sub pixels for one block are obtained. The larger the total point is, the less likely to cause flicker by changes in brightness.

As just described, when the frame order in which the sub pixel of the same color in the top right pixel of the sub pixel subject to judgment to be in 21st grayscale, the frame order in which the sub pixel subject to judgment to be in 21st grayscale, and the frame order in which the sub pixel of the same color in the bottom right pixel of the sub pixel subject to judgment to be in 21st grayscale are not sequential, it is defined to add a point. More specifically, as the movement of sub pixels of the same color in high brightness by change of frames is quantified, flicker caused by changes in brightness can be judged. By the judgment of this quantification, a pattern of reduced flicker can be obtained. The above-mentioned moving directions are in two kinds of ascending order and descending order, and more specifically, when array numbers of sub pixels of the adjacent top right, subject to judgment and adjacent bottom right are in ascending order of 1, 2 and 3, changes in brightness moves from bottom left to bottom right with reference to the adjacent top right and, when array numbers of sub pixels of the adjacent top right, subject to judgment and adjacent bottom right are in descending order of 3, 2 and 1, moves from top left to top right with reference to the adjacent bottom right. However, directions of movement may be in other directions. More specifically, it may be defined to add a point when arranged as changes in brightness not moving twice sequentially to adjacent pixels, i.e. 8 pixels on the left, right, top and bottom and diagonally on the top left, top right, bottom left and bottom right, by change of frames.

Forty eight pieces of points for evenness in brightness and twelve pieces of points for changes in brightness are summed. The larger the total point is, the less likely to cause flicker overall.

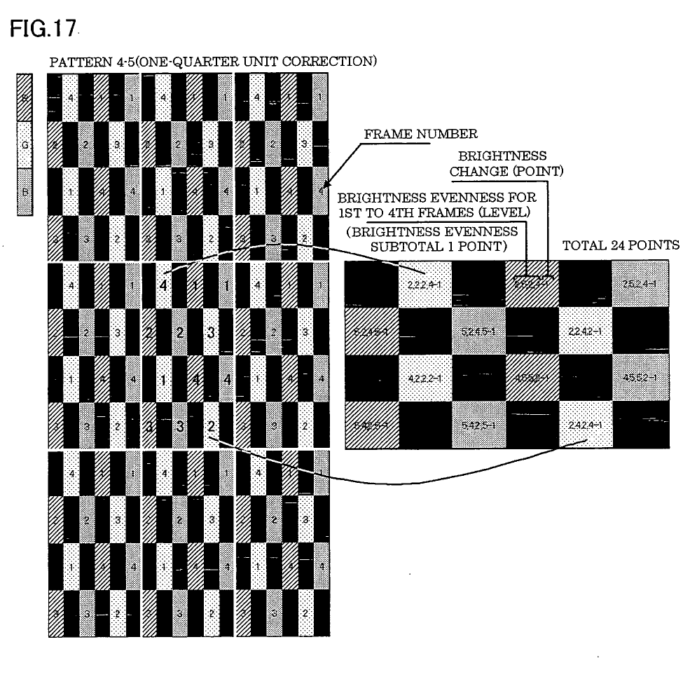

FIG. 17 shows an example of a pattern with a large total point. This pattern is numbered as 4-5. In the pattern 4-5, it is arranged so that there is only one green sub pixel within the same group and array numbers of adjacent sub pixels of the same color are not in sequence of three or more. As shown in FIG. 17, as the point for evenness in brightness is 1 and the point for changes in brightness is 1 for each sub pixel, the total point becomes 24.

While the second embodiment is for the frame rate control of one-quarter grayscale in which one frame out of four frames is one grayscale higher than others, this can be applied to those of one-half grayscale and three-quarter grayscale. The one-half grayscale is considered as twice the one-quarter grayscale and all that is required is to change the array numbers from 4 to 2 and from 3 to 1. The three-quarter grayscale is considered as the one-quarter grayscale in reverse polarity and therefore the one-quarter grayscale is applied.

While the aforementioned correction data table stores the correction data in integer numbers, experimental values including decimal numbers may be used. In this case, for cycle frames of N, the correction data needs to be in 1/N grayscale unit.

While the above-mentioned embodiments are applied to a liquid crystal panel, the invention is also applicable to an organic electroluminescent (EL) panel.

What is claimed is:

1. A dual image display device comprising:
a dual image synthesizer that outputs a dual image in which a display grayscale brightness of sub pixels is set and the sub pixels of individual images for two visual directions are adjacent to each other in a gate line direction; and
a crosstalk corrector that corrects the grayscale of a sub pixel subject to correction based on the grayscale of an adjacent sub pixel,
the crosstalk corrector carrying out corrections in K grayscale for N1 frames and corrections in K+1 grayscale for N−N1 frames within N frames where K being an integer, N being a positive integer of 2 or more, and N1 being a positive integer of less than N.

2. The dual image display device according to claim 1, further comprising:
a data table that stores previously obtained correction data corresponding to grayscales between adjacent sub pixels in a gate line direction,
the crosstalk corrector carrying out corrections based on the data table.

3. The dual image display device according to claim 2, wherein the data table is configured as a matrix in every other grayscale and stores grayscale correction data in integers, and the crosstalk corrector obtains correction data of skipped grayscales in every other grayscale from the data table by interpolation.

4. The dual image display device according to claim 3, wherein the crosstalk corrector is defined as N=4.

5. The dual image display device according to claim 1, wherein the crosstalk corrector mixes sub pixels of corrections in the K grayscale and sub pixels of corrections in the K+1 grayscale in the same frame of an image for the same visual direction.

6. The dual image display device according to claim 5, wherein an image for the same visual direction is configured with a plurality of blocks composed of a predefined number of sub pixels as one block, array numbers from 1 to N that define an order of corrections in the K grayscale and corrections in the K+1 grayscale within N frames in one cycle are set, and the number of the array numbers 1 to N assigned to sub pixels in one block is defined to be the same.

7. The dual image display device according to claim 5, wherein sub pixels of individual images for two visual directions are arranged in a checkered pattern, and a set of red, green and blue sub pixels of an image for the same visual direction and in the same grayscale correction is arranged as to line up in a V-shape for one individual image and in a Λ-shape for the other individual image.

8. The dual image display device according to claim 5, wherein sub pixels of individual images for two visual directions are arranged in a checkered pattern, and a set of red, green and blue sub pixels of an image for the same visual direction and in the same grayscale correction is arranged as to line up diagonally in the same direction for two individual images.

9. The dual image display device according to claim 5, wherein sub pixels of individual images for two visual directions are arranged in a checkered pattern, and a set of red, green and blue sub pixels of an image for the same visual direction and in the same grayscale correction is arranged as to line up diagonally in different directions from each other for two individual images.

10. The dual image display device according to claim 5, wherein sub pixels of individual images for two visual directions are arranged in a checkered pattern, and a set of red, green and blue sub pixels of an image for the same visual direction and in the same grayscale correction is arranged as to line up diagonally one sub pixel apart.

11. The dual image display device according to claim 5, wherein sub pixels of individual images for two visual directions are arranged in a checkered pattern, and a set of red, green and blue sub pixels of an image for the same visual direction and in the same grayscale correction is arranged as to be different for patterns of odd-numbered frames and for patterns of even-numbered frames.

12. The dual image display device according to claim 5, wherein sub pixels of individual images for two visual directions are arranged in a checkered pattern, and a set of red, green and blue sub pixels of an image for the same visual direction and in the same grayscale correction is arranged as to line up diagonally for frames of either odd-numbered frames or even-numbered frames and as to line up in a V-shape or in a Λ-shape for the other frames.

13. The dual image display device according to claim 5, further comprising:
a selector that selects a pattern by an external input out of a plurality of patterns of mixed areas of corrections in the K grayscale and corrections in the K+1 grayscale.

14. The dual image display device according to claim 1, further comprising:
a selector to select a mode by an external input out of a plurality of modes with different values of the N.

15. The dual image display device according to claim 5, wherein the brightness of green sub pixels is set higher than the brightness of red sub pixels and the brightness of blue sub pixels for the same grayscale, sub pixels of individual images for two visual directions are arranged in a checkered pattern, and the sub pixels of an image for the same visual direction are arranged as not to have any green sub pixels for the same visual direction in six directions of top left, top right, bottom left, bottom right, left and right with a green sub pixel being in the center.

16. The dual image display device according to claim 5, wherein sub pixels of individual images for two visual directions are arranged in a checkered pattern, and the sub pixels of an image for the same visual direction are arranged in a way that three sub pixels of the same color in K+1 grayscale carried out in K+1 grayscale for one frame within N frames do not move twice sequentially to adjacent pixels by change of frames.

17. A dual image display device comprising:
a dual image synthesizer that outputs a dual image in which one pixel is composed of three sub pixels of red, green and blue, a display grayscale brightness of the sub pixels is set and sub pixels of individual images for two visual directions are adjacent to each other in a gate line direction; and
a crosstalk corrector that corrects the grayscale of a sub pixel subject to correction based on the grayscale of an adjacent sub pixel,
the crosstalk corrector carrying out corrections in K grayscale for N1 frames and corrections in K+1 grayscale for N−N1 frames within N frames where K being an integer, N being a positive integer of 2 or more, and N1 being a positive integer of less than N, an image for the same visual direction being configured with a plurality of blocks each composed of M1 sub pixels, array numbers from 1 to N that define an order of corrections in the K grayscale and corrections in the K+1 grayscale within N frames in one cycle being set, the number of array numbers 1 to N assigned to sub pixels in one block being defined to be the same, and the brightness of green sub pixels being approximately L times higher than the brightness of red sub pixels and blue sub pixels for the same grayscale,
the brightness of green sub pixels being calculated as approximately L times higher than the brightness of red and blue sub pixels, and a group whose total number of a sub pixel subject to judgment and adjacent sub pixels thereof is M2 being set within one block,
with the corrections for the entire sub pixels in the one block carried out by corrections in the K grayscale for N−1 frames and by corrections in the K+1 grayscale for one frame, a pattern being adopted for assigning the array numbers to one block in which an average brightness of one sub pixel in one group becomes approximately the same as an average brightness of one sub pixel in the block at least once within N frames for the entire sub pixels in the one block.

18. A dual image display device comprising:
a dual image synthesizer that outputs a dual image in which one pixel is composed of three sub pixels of red, green and blue, a display grayscale brightness of the sub pixels is set and sub pixels of individual images for two visual directions are adjacent to each other in a gate line direction; and
a crosstalk corrector that corrects the grayscale of a sub pixel subject to correction based on the grayscale of an adjacent sub pixel,
the crosstalk corrector carrying out corrections in K grayscale for N1 frames and corrections in K+1 grayscale for N−N1 frames within N frames where K being an integer, N being a positive integer of 2 or more, and N1 being a positive integer of less than N, an image for the same visual direction being configured with a plurality of blocks each composed of M1 sub pixels, array numbers from 1 to N that define an order of corrections in the K grayscale and corrections in the K+1 grayscale within N frames in one cycle being set, and the number of array numbers 1 to N assigned to sub pixels in one block being defined to be the same,
with the corrections of the entire sub pixels in the one block carried out by corrections in the K grayscale for N−1 frames and by corrections in the K+1 grayscale for one frame, a pattern being adopted for assigning the array numbers to one block in which three frame orders of a sub pixel of the same color in a first adjacent pixel to the sub pixel subject to judgment to be in K+1 grayscale, of the sub pixel subject to judgment to be in K+1 grayscale, and of a sub pixel of the same color in a second adjacent pixel to the sub pixel subject to judgment to be in K+1 grayscale are not sequential for the entire sub pixels in the one block.
